(19) United States
(12) Patent Application Publication
(10) Pub. No.: US 2025/0239021 A1
(43) Pub. Date: Jul. 24, 2025

(54) AN AI-ASSISTED COLLABORATIVE PROTOTYPING SYSTEM

(71) Applicants: Kevin Curry, San Francisco, CA (US); Andre Venancio, San Francisco, CA (US); Damien Motini, San Francisco, CA (US); Josh Chanthavisay, San Francisco, CA (US); Ivan Daum, San Francisco, CA (US); Seyma Ekiz, San Francisco, CA (US)

(72) Inventors: Kevin Curry, San Francisco, CA (US); Andre Venancio, San Francisco, CA (US); Damien Motini, San Francisco, CA (US); Josh Chanthavisay, San Francisco, CA (US); Ivan Daum, San Francisco, CA (US); Seyma Ekiz, San Francisco, CA (US)

(21) Appl. No.: 18/419,450

(22) Filed: Jan. 22, 2024

(51) Int. Cl. G06T 19/00; G06F 40/40

(52) U.S. Cl. CPC G06T 19/00; G06F 40/40

(57) ABSTRACT

An AI-assisted prototyping system and method that includes receiving, at a computing device, a natural language (NL) input associated with a world, scene or asset, and transmitting the NL input and a context to the AI agent configured to generate computer-executable instructions corresponding to the NL input, where the context includes instruction format data, translations of NL inputs to instructions, or segments of programs. The system receives, from the AI agent, a set of generated instructions corresponding to the NL input and configured to update the world, scene or the asset, generates a set of finalized instructions based on the set of generated instructions, and updates, at the computing device, the world, scene or asset by executing the set of finalized instructions. In some examples, the AI agent is selected based on determining one of at least an intent, request scope or topic associated with the NL input.

### TECHNICAL FIELD

The disclosed subject matter relates generally to the technical field of computer graphics and, in one specific example, to a system for AI-assisted collaborative, real-time 3D design and/or prototyping.

### BACKGROUND

Creative teams in many domains such as 2D design, 3D modeling or animation, architectural design, or urban planning benefit from current developments in collaborative prototyping systems integrated with external tools or code libraries.

### BRIEF DESCRIPTION OF THE SEVERAL VIEWS OF THE DRAWINGS

Some embodiments are illustrated by way of example and not limitation in the figures of the accompanying drawings.

FIG. 1 is a network diagram illustrating a system within which various example embodiments may be deployed.

FIG. 2 is a block diagram illustrating an AI-assisted collaborative prototyping system, according to some examples.

FIG. 3 is a block diagram illustrating an AI-assisted collaborative prototyping system, according to some examples.

FIG. 4 is a block diagram illustrating an AI-assisted collaborative prototyping system, according to some examples.

FIG. 5 is a block diagram illustrating an AI-assisted collaborative prototyping system, according to some examples.

FIG. 6 is a flow diagram illustrating a method implemented by an AI-assisted collaborative prototyping system, according to some examples.

FIG. 7 is an illustration of a user interface (UI) for an AI-assisted collaborative prototyping system, according to some examples.

FIG. 8 is an illustration of a UI for an AI-assisted collaborative prototyping system, according to some examples.

FIG. 9 is an illustration of a UI for an AI-assisted collaborative prototyping system, according to some examples.

FIG. 10 is an illustration of a UI for an AI-assisted collaborative prototyping system, according to some examples.

FIG. 11 is an illustration of a UI for an AI-assisted collaborative prototyping system, according to some examples.

FIG. 12 is an illustration of a UI for an AI-assisted collaborative prototyping system, according to some examples.

FIG. 13 is an illustration of a UI for an AI-assisted collaborative prototyping system, according to some examples.

FIG. 14 is an illustration of a UI for an AI-assisted collaborative prototyping system, according to some examples.

FIG. 15 is an illustration of a UI for an AI-assisted collaborative prototyping system, according to some examples.

FIG. 16 is an illustration of a UI for an AI-assisted collaborative prototyping system, according to some examples.

FIG. 17 is a block diagram illustrating an example of a software architecture that may be installed on a machine, according to some examples.

FIG. 18 is a block diagram illustrating components of a machine, according to some examples, able to read instructions from a machine-readable medium (e.g., a machine-readable storage medium) and perform any one or more of the methodologies discussed herein.

FIG. 19 is a block diagram illustrating a machine learning program, according to some examples.

### DETAILED DESCRIPTION

Currently available tools provide powerful capabilities in specific areas like 2D design, 3D modeling, animation, or coding, but lack an integrated end-to-end solution covering the full spectrum of needs for creative teams. Solutions like Adobe Creative Cloud®, Figma®, Blender®, AutoDesk® tools, or Canva®, come up short when it comes to enabling seamless collaboration in 3D spaces or leveraging AI to enhance workflows. Other solutions, like Unreal Engine® and Mattercraft®, eliminate coding requirements in 3D development, but have a steep learning curve for non-technical users. Many current solutions are lacking with respect to seamless integration with external tools and code libraries.

Examples in the disclosure herein refer to a system for AI-aided, collaborative prototyping in real-time 3D (RT3D) environments. The prototyping system uses AI-based functionality to assist users (e.g., designers, architects, etc.) throughout the creative process. In some examples, the prototyping system is Web-based. The prototyping system processes received natural language (NL) inputs and uses them to generate corresponding computer-executable instructions for updating 3D models, scenes, or assets. The prototyping system processes these NL inputs using one or more AI agents, and/or considering context that includes instruction format data, translations of NL inputs to instructions, or segments of executable programs. The prototyping system produces a set of generated instructions that are then refined into finalized instructions for execution. By being configured to process NL input, the prototyping system enables accessibility for non-technical users, as well as faster direction from technical users who can use either NL or code inputs, as needed.

The prototyping system enables real-time 3D visualization and/or collaboration of multiple users both within the prototyping system's interface, as well as across an integrated design and/or graphics ecosystem (e.g., including editors such as the Unity®, Editor, or other editors). The prototyping system thus enables multiple users to simultaneously iterate, edit, refine and/or visualize changes to a world, scene, asset, or other design elements, in a shared 3D space. The prototyping system supports seamless integration with a graphics engine (e.g., Unity®, Engine). Customizable permissions settings aid workflow management across individuals and teams. The prototyping system is also configured to export 3D and AR/VR content to various platforms, as needed. By using AI to automate design tasks and to reliably interpret NL input within an iterative asset design pipeline, the prototyping system improves the flow and efficiency of collaborative design projects, game development, film and animation development (e.g., by enabling real-time prototyping for 3D scenes), virtual reality (VR) experience design, architecture or urban planning (e.g., by enabling rapid prototyping of 3D models for structures and/or environments), industrial design projects, or other projects.

Thus, the prototyping system can include an AI-assisted, natural language-driven interface for 3D design, a real-time collaborative environment with customizable permissions, and/or support deep integration with one or more ecosystems (e.g., the Unity®, ecosystem), among other capabilities, which makes it an efficient and accessible prototyping option for users of varying technical backgrounds.

In some examples, the prototyping system receives, for example via a UI at a computing device, a NL input associated with a world, scene, asset or other design elements or objects. The prototyping system is enabled to receive and/or process the NL input via one or more input modalities, such as text, voice command, or other modalities. The prototyping system can select an AI agent enabled to generate one or more computer-executable instructions corresponding to the NL input. In some examples, the prototyping system uses a predetermined AI agent, thus bypassing a selection step for the AI agent. The prototyping system transmits the NL input and a context to the AI agent. The context includes instruction format data (e.g., instruction syntax or parameter information, etc.), translations of NL inputs to instructions, segments of programs (e.g., well-formed segments of executable programs such as procedures of subroutines, entire executable programs, etc.), data or data files, or other potential context information. The prototyping system receives, from the AI agent, output including a set of generated instructions, or a set of generated files including generated instructions and/or data (e.g., data files or paths to data files) corresponding to the NL input. The generated instructions and/or generated files can be enabled to create, select, update and/or delete the world, the scene or the asset. The prototyping system generates a set of finalized instructions and/or finalized files (e.g., executable files including instructions and/or data or paths to data files, etc.) based on the set of generated instructions and/or generated files. The prototyping system creates, selects, updates and/or deletes the world, scene, asset or other object by executing or using the set of finalized instructions and/or finalized files. In some examples, the updates are displayed to one or more users of a collaborative design session via a second UI, for example at the computing device. In some examples, the second UI can be the same as the initial UI that received the NL input.

In some examples, the prototyping system determines NL input-associated information that includes one or more of at least an intent associated with the NL input, a request scope associated with the NL input, or a topic associated with the NL input. In some examples, selecting the AI agent uses such determined NL input-associated information. In some examples, the intent associated with the NL input is determined to be a select intent, create intent, add intent, update intent, move intent or delete intent. In some examples, based on determining that the request scope of the NL input is associated with an asset or a scene, the prototyping system generates the context by adding to the context the instruction format data and/or the translations of NL inputs to instructions. In some examples, based on determining that the intent associated with the NL input is a create intent, and/or that the request scope of the NL input is associated with a world, generating the context further includes adding to it executable programs or program segments. Examples of program segments include well-formed or executable program segments (or code snippets), such as procedures, subroutines, templates, or other program segments.

In some examples, generating the set of finalized instructions and/or finalized data or data files includes transmitting an input and/or a second context to the AI agent. The input can include one or more of the instructions in the set of generated instructions, or a subset of the generated files. The second context includes verification information associated with the one or more generated instructions and/or subset of the generated files. The prototyping system receives, from the AI agent, a second set of generated instructions and/or second set of generated files. The prototyping system can generate the set of finalized instructions and/or finalized files (e.g., including executable instructions and/or data and/or paths to data) based on the set of generated instructions, generated files, the second set of generated instructions, or the second set of generated files.

In some examples, the prototyping system selects a second AI agent enabled to generate a second set of instructions or generated files corresponding to the NL input. In some examples, the second AI agent is a predetermined second AI agent (bypassing the selection step). Generating the finalized set of instructions and/or finalized files can be further based on the second set of instructions and/or second set of generated files.

In some examples, the prototyping system transmits to the AI agent context that includes a set, sequence or history of previous NL inputs, or a set, sequence or history of previous (NL input, set of finalized executable instructions) pairs.

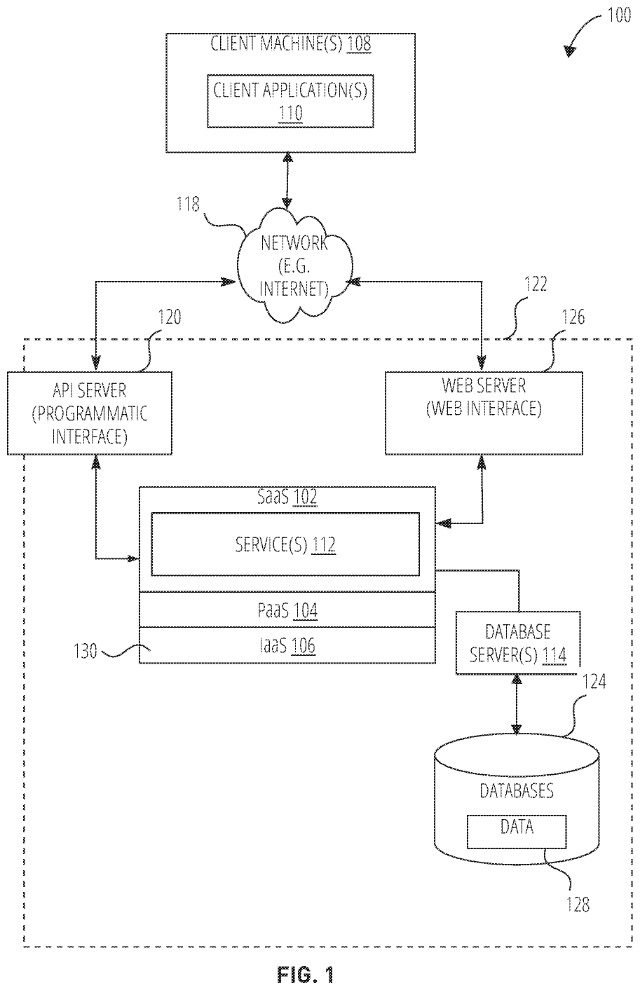

FIG. 1 is a network diagram depicting a system 100 within which various example embodiments described herein may be deployed. A networked system 122 in the example form of a cloud computing service, such as Microsoft Azure or other cloud service, provides server-side functionality, via a network 118 (e.g., the Internet or Wide Area Network (WAN)) to one or more endpoints (e.g., client machine(s) 108). FIG. 1 illustrates client application(s) 110 on the client machine(s) 108. Examples of client application(s) 110 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, contact center applications, digital content creation applications (e.g., game development applications) or game applications. Each of the client application(s) 110 may include a software application module (e.g., a plug-in, add-in, or macro) that adds a specific service or feature to the application.

An API server 120 and a web server 126 are coupled to, and provide programmatic and web interfaces respectively to, one or more software services, which may be hosted on a software-as-a-service (SaaS) layer or platform 102. The SaaS platform may be part of a service-oriented architecture, being stacked upon a platform-as-a-service (PaaS) layer 104 which, may be, in turn, stacked upon an infrastructure-as-a-service (IaaS) layer 106 (e.g., in accordance with standards defined by the National Institute of Standards and Technology (NIST)).

While the applications (e.g., service(s)) 112 are shown in FIG. 1 to form part of the networked system 122, in alternative embodiments, the applications 112 may form part of a service that is separate and distinct from the networked system 122.

Further, while the system 100 shown in FIG. 1 employs a cloud-based architecture, various embodiments are, of course, not limited to such an architecture, and could equally well find application in a client-server, distributed, or peer-to-peer system, for example. The various server services or applications 112 could also be implemented as standalone software programs. Additionally, although FIG. 1 depicts machine(s) 108 as being coupled to a single networked system 122, it will be readily apparent to one skilled in the art that client machine(s) 108, as well as client application(s) 110 (such as game applications), may be coupled to multiple networked systems, such as payment applications associated with multiple payment processors or acquiring banks (e.g., PayPal, Visa, MasterCard, and American Express).

Web applications executing on the client machine(s) 108 may access the various applications 112 via the web interface supported by the web server 126. Similarly, native applications executing on the client machine(s) 108 may access the various services and functions provided by the applications 112 via the programmatic interface provided by the API server 120. For example, the third-party applications may, utilizing information retrieved from the networked system 122, support one or more features or functions on a website hosted by the third party. The third-party website may, for example, provide one or more promotional, marketplace or payment functions that are integrated into or supported by relevant applications of the networked system 122.

The server applications may be hosted on dedicated or shared server machines (not shown) that are communicatively coupled to enable communications between server machines. The server applications 112 themselves are communicatively coupled (e.g., via appropriate interfaces) to each other and to various data sources, so as to allow information to be passed between the server applications 112 and so as to allow the server applications 112 to share and access common data. The server applications 112 may furthermore access one or more databases 124 via the database server(s) 114. In example embodiments, various data items are stored in the databases 124, such as the system's data items 128. In example embodiments, the system's data items may be any of the data items described herein.

Navigation of the networked system 122 may be facilitated by one or more navigation applications. For example, a search application (as an example of a navigation application) may enable keyword searches of data items included in the one or more databases 124 associated with the networked system 122. A client application may allow users to access the system's data 128 (e.g., via one or more client applications). Various other navigation applications may be provided to supplement the search and browsing applications.

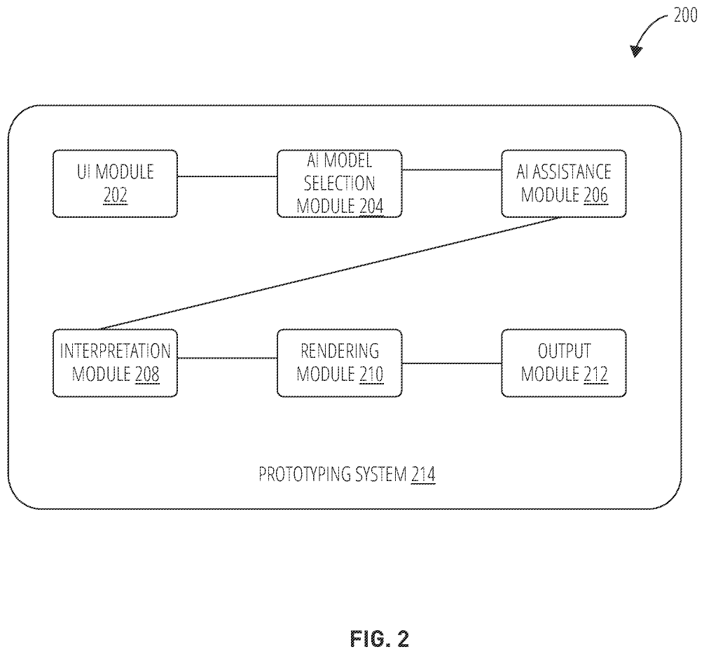

FIG. 2 is a block diagram 200 illustrating an AI-assisted collaborative prototyping system 214, according to some examples. The prototyping system 214 includes at least a UI module 202, an AI model selection module 204, an AI assistance module 206, an interpretation module 208, a rendering module 210, and/or an output module 212. The prototyping system 214 receives a user-provided input, and maps it to a set of application-specific instructions (e.g., commands) that are then executed in order to generate and/or update a scene or asset in the context of a design session.

In some examples, prototyping system 214 receives the user-provided input via the UI module 202. The input can be a natural language (NL) prompt submitted via text, speech, a combination of text and speech, or other input modalities. As an illustrative example, the discussion refers to the input as a prompt throughout. The prompt can refer to a world, scene, asset, or other objects or design elements (the rest of the description focuses on the illustrative examples of worlds, scenes, or assets). The prompt can indicate requests such as select, generate, add, modify or edit, move, delete or other requests. In some examples, the prototyping system 214 saves a history of user prompts, corresponding system output and/or additional information provided to the system (e.g., contexts). The saved history can be user-specific, or aggregated over a population of users, world, scene or asset types, or using other aggregation criteria. In some examples, the UI module 202 can process a sequence of multiple user prompts entered at the same time by the user. For example, the prototyping system 214 can iterate through a batch of user requests, handling each one as described below. In some examples, the UI module 202 can start a design session by automatically suggesting one or more starting queries or requests, visualized via the UI as potential NL inputs. Upon receiving a user selection of one of the suggested NL inputs, the UI module 202 can add it to the current history and/or process it and/or transmit it downstream. In some examples, the suggested NL inputs are generated automatically by the prototyping systems 214 based on one or more histories generated as described above.

The AI model selection module 204 receives as input a user prompt. In some examples the AI model selection module 204 receives at least one history of previous K prompts, and/or the corresponding set of commands generated by the prototyping system 214 for each of the previous prompts. The history can be user-specific, as detailed above, or aggregated according to one or more aggregation criteria. In some examples, the AI model selection module 204 receives a context including information about the format (e.g., syntax, parameters, etc.) of application-specific commands (render commands, etc.), examples of mappings between user prompts and sets of application commands, or examples of routines or programs used by the prototyping system 214 to generate and/or update worlds, scenes, assets and/or other design elements. Given the user prompt, history data and/or context information, the AI model selection module 204 automatically determines which AI model or models should handle the user prompt. Factors used in determining the one or more AI models include automatically computed prompt complexity, previous AI model performance, measures of domains-specific AI model expertise, or other factors. For example, the AI model selection module 204 can have access to an AI model expert in generating commands in an application-specific language (e.g., a code expert), an AI model expert in high-level description layout generation, an AI model adapted to iterative development in a particular framework (Sketch, etc.), an AI expert for generating animations based on a user request for a character to perform one or more specific actions, an AI expert for adding behaviors and/or properties to 3D objects, an AI expert for adding textures and/or materials for 3D objects, or other experts. The AI model selection module 204 can use a separate AI model to select the most appropriate AI model to which to redirect the user input or request for processing. If more than one AI model is selected, the outputs produced by the models (described below) can be combined to generate a set of executable instructions. In some examples, the AI selection module 204 can be bypassed: the prototyping system 214 can use a predetermined AI agent (e.g., an AI agent specified by a developer, by a user, indicated in a configuration file, and so forth). In such examples, the user prompt, history and/or context can be forwarded by the UI module 202 directly to the AI assistance module 206.

The AI assistance module 206 receives, for example from the AI model selection module 204, the user prompt, history and/or context. It submits this information to the one or more selected AI model. Each such AI model generates completions, suggestions and/or descriptions that include one or more application-specific commands enabled to implement the user request. In some examples, the respective commands can be outputted as part of a file of a prespecified format (e.g., a JSON file, etc.). The generated commands correspond to application-specific commands, used to retrieve, specify, render, manipulate and/or modify assets or scenes, among other operations.

In some examples, the AI assistance module 206 iterates by submitting follow-up and/or clarification and/or disambiguating prompts. Such prompts can be generated using previously generated system answers, a prompt history, one or more contexts, and other information. Each AI model can be a generative AI model, a retrieval AI models, or another type of model. The output of each AI model is submitted to the interpretation module 208, which parses, verifies and/or converts the output to executable commands (e.g., render commands).

The rendering module 210 takes executable commands as input and executes them, using for example a graphics pipeline and/or an engine. The rendering module 210 provides tools for asset manipulation as needed. A rendered output scene and/or assets are displayed to one or more users via the output module 212. In some examples, the output module 212 is the same as or part of the UI module 202. In some examples, the functionality of the UI module 202 and/or that of the output module 212 are integrated in a design environment. In some examples, the output module 212 enables one or more additional UI modules, including for example a debugging UI module enabled to display and/or edit the generated commands. The prototyping system 214, via the UI module 202 and/or output module 212, enables interactive display and/or editing for a world, scene, asset, or other elements and their properties. The output module 212 and/or UI module 202 can highlight changes over a previous iteration, and/or enable further iteration and refinement. The output module 212 can elicit, recommend, receive, or process follow-up prompts by the user who provided the initial NL input, or by other users engaged in a collaborative design session.

In some examples, the prototyping system 214 automatically suggests one or more follow-up queries or requests, visualized for example via the UI module 202. Upon receiving a user selection of one of the suggested NL inputs, the UI module 202 can add it to the current history and/or process it and/or transmit it downstream. In some examples, the suggested NL inputs are generated automatically by the prototyping systems 214 based on one or more previously generated histories as described earlier in the disclosure.

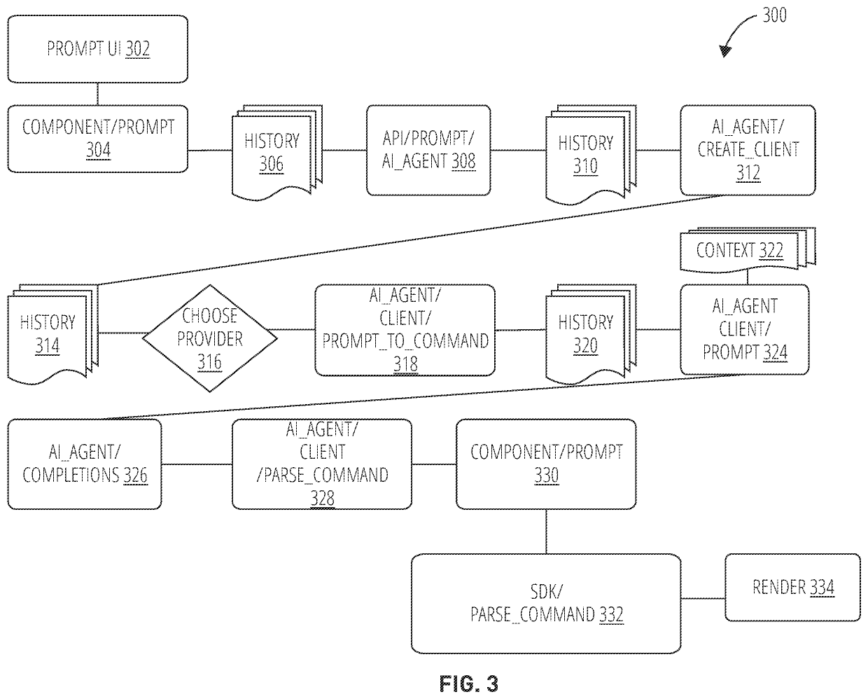

FIG. 3 is a block diagram 300 illustrating an AI-assisted collaborative prototyping system 214, according to some examples. FIG. 3 illustrates an example workflow for the AI-assisted collaborative prototyping system 214. In some examples, modules included in this workflow can be combined, and/or unified based on their functionality. In some examples, additional modules can be added to the workflow. In some examples, the functionality illustrated is available via an API (e.g., an internal API, an external API), or a software development kit (SDK).

The prototyping system 214 includes a prompt UI 302 module that receives a user input prompt (e.g., a NL prompt). Given the input prompt, the prompt UI 302 transmits it to component/prompt 304 (corresponding for example to a method call associated with a prototyping system 214 module), or to an API call (e.g., a design studio and/or editor API).

In some examples, the prototyping system 214 passes along, as part of the overall data flow, a history (see 306, 310, 314, etc). The history includes the last K user prompts (where K=1/2/3/5/10/15/etc.), the last K user prompts together with the resulting system output in the form of sets of commands, or other information. In some examples, the history can include information from the most recent user session, the most recent N user sessions, user prompt and/or system output information aggregated with respect to a user, a population of users, a type of world, scene or asset, or a specific world, scene or asset, an automatically-determined intent (e.g., generate a scene or asset, delete a scene or asset, etc.), or other aggregation criteria.

The prototyping system 214, via API/prompt/AI_agent 308 and/or AI_agent/create_client 312, creates an AI agent client. In some examples, the prototyping system 214 can select, using the choose_provider 316 module, one or more providers of AI agents. For example, the prototyping system 214 can select one or more conversational, dialogue, or chatbot agents from various providers. Such agents can be agents using large language models (LLMs). Selected AI agents can be external (e.g., GPT-3.5, GPT-4, GPT-4.5 available from OpenAI or Microsoft Azure, Claude from Anthropic AI, Cohere Command, Falcon, LaMDA, LLaMa, Orca, PaLM, or other third-party agents). Selected AI agents can use models internal to the prototyping system 214, such as models trained from scratch on data specific to the domain of the prototyping system 214. Selected AI agents can use a combination of external and internal models and data, such as pre-trained external models subsequently fine-tuned on domain-specific data associated with the prototyping system 214. In some examples, selecting one or more AI agents is based on factors such as automatically determined prompt complexity, available information about specific domain expertise, accuracy, robustness and/or speed of one or more AI models, or other factors.

The prototyping system 214, via AI_agent/client/prompt_to_command 318 and/or AI_agent/client/prompt 324, provides the selected AI agent with the user prompt, the history, and/or a context 322. The context 322 can include details about how the input prompt should be processed by the AI agent, and/or how the output should be provided (e.g., type and/or format of output file, fields or information to include or omit, or other details). In some examples, the context 322 includes instruction format data such as format, syntax and/or parameter information associated with application-specific instructions (e.g., commands) and/or application-specific coding language used by the prototyping system 214 (e.g., to render and/or manipulate worlds, scenes, or assets). In some examples, the context 322 includes procedures, subroutines, templates, other program segments or programs corresponding to implementations of a scene, asset, world, or other design artifacts. In some examples, the context 322 includes data, data files or paths to data files (see Table 2 in the description of FIG. 3). In some examples, the history (e.g., 306, 310, 320, etc.) can be included in context 322.

In some examples, the information in context 322 is determined and/or refined based on a detected intent and/or request scope and/or topic of the user input. For example, the prototyping system 214 workflow can include an additional step detecting at least one intent, at least one request scope, or at least one topic of the input prompt (e.g., the detecting including making one or more calls to an AI agent). Examples of intents include “select,” “generate,” “add,” “update”, “move” or “delete,” the more specific “generate X”, “add X,” “update X”, “move X” or “delete X” where X can be a specific world, scene, asset, character, property/attribute/behavior of a world/scene/asset/character, or other intents. In some examples, more than one overlapping intents can be detected. For example, an input prompt such as “move house 40 m to the right” can have an associated “move” intent, as well as an associated “update [position of house]” intent, among other intents. Examples of properties or attributes can include position, coordinates, speed, acceleration, texture, color, or other attributes. Examples of request scope include world-level request scope, scene-level request scope, asset-level or character-level, request scope, or other request scopes or types. Request scope can be binary, such as “narrow” (e.g., corresponding to an asset) or “broad” (corresponding to a scene, world, etc.). Topics associated with the NL input can correspond to the type of structure, scene, or world indicated by the NL input, among other topics.

In some examples, the input prompt is determined to have a “narrow” scope or refer to an asset-level or scene-level request, context 322 can include information associated with command generation. If the input prompt is determined to be “broad” in scope, or associated with a world-level request (e.g., “I'd like to create a zombie island adventure game”), context 322 can incorporate procedures and/or code and/or templates for generating a set of scenes and/or assets corresponding to such a game, if such information is retrievable by the prototyping system 214.

The prototyping system 214 retrieves, via AI_agent/completions 326, completions and/or suggestions from the selected AI agent (e.g., the AI agent client). The AI agent output includes one or more commands (e.g., instructions) corresponding to an implementation of the input prompt. In some examples, the AI agent output includes files (e.g., well-formed files, executable files) including programs, program segments (e.g., well-formed, executable program segments or code snippets such as procedures or subroutines), data, pointers or paths to data and/or code files, or other code and/or configuration file artifacts. Such files can correspond to templates for objects or artifacts, where the templates are enabled to be instantiated. Such files can correspond to instantiated templates, or fully described or implemented objects or artifacts. Object or artifact examples include worlds, scenes with specified compositions (e.g., a scene containing buildings, trees and/or people), assets or characters (e.g, a 3D model element, an environmental lighting element, a lamp, a rocket, a human figure, etc.), behaviors, properties or attributes of a world, scene, assets or characters (e.g., texture, color), or other design elements. The files produced by the AI agent can have a prespecified file format (e.g., JSON format). The files can be well-formed, with a predefined structure corresponding to a language for specifying templates, or with a structure of an executable program in a language associated with a graphics pipeline, design studio, or other execution environment. The files produced by the AI agent can include NL descriptions or comments indicating the semantics of the templates, instantiated templates and/or command set functionality (e.g., “this is a scene containing buildings, trees and people”, “this is a 3D model element”, “this is a lamp”, etc.). The files produced by the AI agent can include additional comments, and/or explanations of the output commands and/or data were generated.

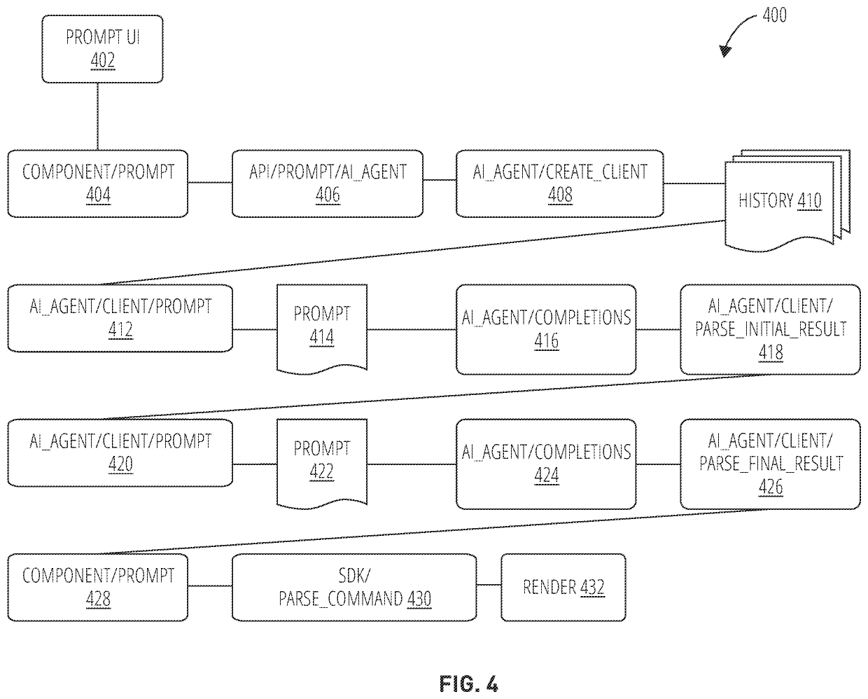

The prototyping system 214 can parse, verify, modify and/or convert generated AI agent output files into one or more finalized, executable commands and/or finalized executable files (e.g., including command or instruction sets, data or paths to data) via the AI_agent/client/parse_command 328, component/prompt 330, and/or SDK/parse_command 332 elements. For example, the prototyping system 214 can use component/prompt 330 to verify that the parsed AI agent output meets conditions enumerated in context 322 information (e.g., no extraneous explanations, no non-executable content, etc.), or to modify the parsed AI agent output accordingly. In some examples, multiple parse modules implement different levels of parsing and/or verification—for example AI_agent/client/parse_command 328 implements an initial extraction of commands from a file in a particular format, while SDK/parse_command 332 implements further processing of the command set, such as identifying procedures, subroutines, or other elements of the command set. In some examples, the prototyping system 214 uses a unified module implementing a parsing functionality. In some examples, the prototyping system 214 performs one or more follow-up and/or clarification iterations, refining the set of generated commands and/or files (see FIG. 4). Example finalized, executable commands corresponding to an input prompt include add commands (e.g., add node, add behavior to node, etc.), update commands (update node, update behavior, etc.), remove commands (e.g., remove node, remove behavior), or other commands. As mentioned above, example finalized, executable files can include finalized command or instruction sets, and/or finalized data and/or paths to data. The finalized commands and/or finalized executable files are used by the render 334 module to render the assets (e.g., 3D assets) and/or scene, changes to the assets and/or scene (additions, deletions, etc.), or other design elements.

### Example Context: Command Information

As mentioned above, the prototyping system 214 retrieves command output from a selected AI agent based on a user prompt, history and/or context. In some examples, the context 322 (e.g., see “CommandContext” below) includes information or data related to the type, format, syntax and/or parameters of instructions or commands used by one or more applications associated with a graphics pipeline, graphics engine, or design studio. In some examples, context 322 can include examples of valid translations or mappings from user prompts to executable commands. In some examples, context 322 can include instructions about the type of task (e.g., “building a 3D world), about output format, and/or response elements to be included and/or omitted.

Table 1 illustrates an instance of context 322 focused on instruction-associated information or command-associated information. The example includes, at the end, information related to the output format and/or details to be included and/or omitted.

TABLE 1
Example information about commands.

import { COMMAND } from ′./types.js′;
const WANDER_BEHAVIOR_NAME = ′Wander′;
export const CommandContext = ‘ you are assisting users placing assets in a 3d world build with
threejs. Your replies are always an JSON chunk of commands the application understands.
″${COMMAND.add}″: adds a node (of type: asset, character, marker, bounds)
″${COMMAND.update}″: updated a node ″${COMMAND.remove}″: removes a node
″${COMMAND.addBehavior}″: adds a behavior to a node
″${COMMAND.removeBehavior}″: removes a behavior from a node
″${COMMAND.timeUpdate}″: changes the time of the day.
when a ″${COMMAND.add}″ command is returned it always generates a new uuid. So keep track of
it for me.
Here are some examples of commands you can send: * adds 1 node of key box
{″command″:″${COMMAND.add}″,″node″:[{″uuid″:″1″,″type″:″asset″,″key″:″box″}]}
* adds another {″command″:″${COMMAND.add}″,″node″:[{″uuid″:″2″,″type″:″asset″,″key″:″box″}]}
* adds 3 node of key cube at random positions {″command″:″${COMMAND.add}″,″node″:
[{″uuid″:″3″,″type″:″asset″,″key″:″cube″,″position″:[1,0,0]},
{″uuid″:″4″,″type″:″asset″,″key″:″cube″,″position″:[2,0,1]},
{″uuid″:″5″,″type″:″asset″,″key″:″cube″,″position″:[0,0,3]}]}
* removes 1 node previously generated {″command″:″${COMMAND.remove}″,″node″:[″5″]}
* removes 2 node previously generated {″command″:″${COMMAND.remove}″,″node″:[″4″,″3″]}
* adds a wander behavior to uuid of ″1″
{″command″:″${COMMAND.addBehavior}″,″target″:″1″,″behavior″:
{″type″:″${WANDER_BEHAVIOR_NAME}″}}
* removes a wander behavior from node with uuid of ″1″
{″command″:″${COMMAND.removeBehavior}″,″target″:″1″,″behavior″{″type″:″${WANDER_BEHAVI
OR_NAME}″}}
* locks a node {″command″:″${COMMAND.update}″,″node″:[{uuid:″1″,isLocked:true}]}
* add a playable character
{″command″:″${COMMAND.add}″,″node″:[{″uuid″:″1″,″type″:″character″}]}
* add a zombie
{″command″:″${COMMAND.add}″,″node″:[{″uuid″:″1″,″type″:″character″,″key″:″zombie″}]}
* add a marker {″command″:″${COMMAND.add}″,″node″:[{″uuid″:″1″,″type″:″marker″}]}
* add a trigger bounds {″command″:″${COMMAND.add}″,″node″:[{″uuid″:″1″,″type″:″bounds″}]}
* changes the time of day to midday {″command″:″${COMMAND.timeUpdate}″,″time″:″12″}
* changes the time of day midnight {″command″:″${COMMAND.timeUpdate}″,″time″:″24″}
* changes the time of day to sunrise {″command″:″${COMMAND.timeUpdate}″,″time″:″6″}
* changes the time of day to sunset {″command″:″${COMMAND.timeUpdate}″,″time″:″18″}
* if you can't provide any command {″command″:″${COMMAND.unknown}″}
multiple commands are possible, they need to be added into a new line without commas like:
{″command″:″${COMMAND.add}″,″node″:[{″uuid″:″2″,″key″:″box″}]}
{″command″:″${COMMAND.addBehavior}″,″target″:″2″,″behavior″:{″type″:″${WANDER_BEHAVIOR_{—}
NAME}″}}
or {″command″:″${COMMAND.add}″,″node″:[{″uuid″:″1″,″key″:″box″}]}
{″command″:″${COMMAND.add}″,″node″:[{″uuid″:″2″,″key″:″skeleton″}]}
do not include any explanations, context or notes. only provide a RFC8259 compliant JSON response
following this format without deviation. ‘;

### Example Context: Template Information

In some examples, context 322 includes one or more files enabled to be used by a graphics pipeline, graphics engine and/or application to render a world, scene, assets, or other artifacts, and/or modifications to the world, scene, assets, their behaviors, properties or attributes, or other artifacts. The files can be executable files and/or include executable programs or program segments (e.g., well-formed program segments or code snippets such as procedures or subroutines), data, pointers or paths to data and/or code files, or other code and/or configuration file artifacts. The files can include generic or specific examples of world, scene, asset, character generation, modification or deletion (e.g, templates, instantiated templates, fully implemented or fully described objects or artifacts, etc). For example, the files can represent templates for generating a world, a scene, assets, characters in a scene (e.g., a scene containing buildings, trees and/or people, lights, a 3D model element, etc.), behaviors, properties or attributes of a world, scene, assets or characters (e.g., texture, color, etc.), or other design elements. The files can be well-formed, with a predefined structure corresponding to a language for specifying templates, or with a structure of an executable program in a language associated with a graphics pipeline, graphics engine, design studio, or other execution environment. The files can include NL descriptions or comments indicating the semantics of the templates, instantiated templates and/or command set functionality (e.g., “this is a scene containing buildings, trees and people”, “this is a 3D model element”, “this is a lamp”, etc.). The files can have a prespecified file type or format (e.g., a JSON format).

In some examples, context 322 includes additional information about modifying and/or combining the provided files, instructions, data files and/or configuration files to satisfy user requests. Table 2 below illustrates an instance of context 322 focused on templates and/or sets of commands.

TABLE 2
Template and/or code and/or data examples.

```
import { createNewFrameData } from ′@unity-technologies/ultra-animation′
const assetUrl = (filename: string) =>
‘https://ultradevstorage.blob.core.windows.net/models/${filename}‘
const modelNode = {
type: ′model′,
src: assetUrl(′SimulationEnvironments/Factory/Pallet_FY001.glb′),
translation: [0, 0, 0],
rotation: [0, 0, 0, 1],
scale: [1, 1, 1], }
const stageNode = {
type: ′stage′,
  src: assetUrl(′SimulationEnvironments/Factory/Environment_180ftx101ft_FY001.glb′),
}
const environmentNode = { type: ′environment′, environment: ′navy′, }
const cameraNode = { type: ′camera′, pan: 0, tilt: Math.PI * 0.1, distance: 8, target: [0, 1, 0], }
const timelineNode = { type: ′timeline′, framesData: [createNewFrameData( )], }
export default {
factory: {
nodesData: [{ ...stageNode }, { ...cameraNode }, { ...environmentNode }, { ...timelineNode }],
},
  backyard: {
  nodesData: [
{ ...stageNode, src: assetUrl(′SimulationEnvironments/Backyard/Terrain_55ftx40ft_BY001.glb′) },
{ ...cameraNode },
{ ...environmentNode },
{ ...timelineNode }, ],
},
park: {
nodesData: [
{ ...stageNode,
src: assetUrl(′SimulationEnvironments/Park/Terrain_322ftx300ft_PK001.glb′) },
{ ...cameraNode },
{ ...environmentNode },
{ ...timelineNode }, ],
},
crate: {
  ...modelNode,
src: assetUrl(′SimulationEnvironments/Factory/Vintage_Crate_FY001.glb′)
},
shelvingrackloaded: {
  ...modelNode,
src: assetUrl(′SimulationEnvironments/Factory/ShelvingRack_Loaded_FY001.glb′)
},
rocket: {
...modelNode,
src: assetUrl(′SimulationEnvironments/Museum/Explorer1Rocket_MM001.glb′)
},
sputnik: {
  ...modelNode,
src: assetUrl(′SimulationEnvironments/Museum/Sputnik_MM001.glb′) },
apollocommand: {
...modelNode,
src: assetUrl(′SimulationEnvironments/Museum/ApolloCommand_MM001.glb′) },
filecabinet: {
...modelNode,
src: assetUrl(′SimulationEnvironments/Office/FileCabinet_42in_OF001.glb′) },
  character: { ...modelNode, src: assetUrl(′Mars-Body/BodyTracking_Idle.glb′) }, }
```

FIG. 4 is a block diagram 400 illustrating an AI-assisted collaborative prototyping system 214, according to some examples. The prototyping system 214 receives an input prompt (e.g., via a prompt UI 402). In this example, the input prompt is explicitly illustrated as being passed downstream (e.g., see prompt 414). The workflow in FIG. 4 is broadly similar to that in FIG. 3, with some important differences. First, the workflow in FIG. 4 uses a predetermined AI agent and/or AI agent provider, bypassing the provider determination step in FIG. 3. Second, the workflow in FIG. 4 illustrates how the prototyping system 214 refines or finalizes the set of commands and/or files enabled to implement the request associated with the input prompt. For example, after the prototyping system 214 has retrieved, via AI_Agent/completions 424, an output including the set of commands and/or files including commands and/or data, the prototyping system 214 performs a parse of the initial output via AI_Agent/client/418. Once this step is completed, the prototyping system 214 can iterate, for example by using prompt 422 to query the AI agent again via AI_Agent/completions 424. In some examples AI_Agent/completions 424 and AI_Agent/completions/416 refer to the same method, while in others, different methods can correspond to different types of completions. prompt 422 can include clarification requests with respect to the initially generated output, a follow-up request, or other input types. prompt 422 can include part or all of the initial output of AI_agent/completions 416. The content of prompt 422 can be generated using the initial output retrieved from AI_agent/completions 416, historical prompt data, and/or constraints associated with the desired format of executable rendering commands and/or other inputs. The prototyping system 214 can retrieve an additional output from AI_Agent/completions 424, which can be parsed via AI_agent/client/parse_final_result 426, and/or SDK/parse_command 430.

While the workflow in FIG. 4 shows only one such refinement iteration, the prototyping system 214 can repeat the generation of follow-up prompts and/or retrieval of new textual completions and/or suggestions multiple times, corresponding to either a predetermined number of times K, or based on automatically determining whether a provided constraint is satisfied (e.g., whether the prototyping system 214 has an automatically assessed level of confidence in the validity of the latest textual completions and/or suggestions that transcends a predetermined threshold). As in FIG. 3, the finalized and/or verified executable commands and/or executable files are used by render 334 to implement the associated render and/manipulation operations in the context of the world, scene, asset and/or character.

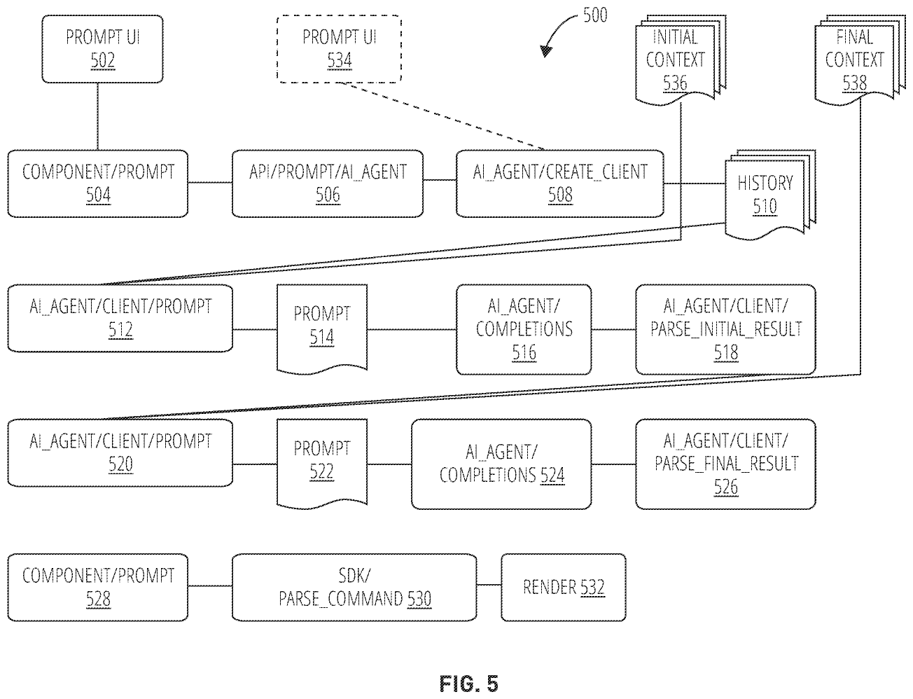

FIG. 5 is a block diagram 500 illustrating an AI-assisted collaborative prototyping system 214, according to some examples. The workflow illustrated in FIG. 5 is broadly similar to those in FIG. 3 and FIG. 4, with some important differences.

First, FIG. 5 illustrates multiple examples of data flows between a prompt UI AI_agent/create_client 508, as shown by data flows involving prompt UI 502 and prompt UI 534. In some examples, multiple versions of the prompt UI module can be present (e.g., both prompt UI 502 and prompt UI 534). In some examples, prompt UI 502 and/or prompt UI 534 can process only NL input, or a mix of NL and graphical inputs.

Second, FIG. 5 shows examples of different contexts being transmitted to AI_agent/completions 516 at different point in the iterative interaction of the prototyping system 214 with the AI agent. An initial context 536 is used as part of the prototyping system 214 first querying the AI agent, via AI_agent/completions 516. A final context 538 is used as part of the prototyping system 214 subsequently querying the AI agent via AI_Agent/completions 524. In some examples, the final context 538 can include clarification and/or editing instructions, formatting instructions, and other content. In some examples, the final context 538 can include part or all of the initial context 536.

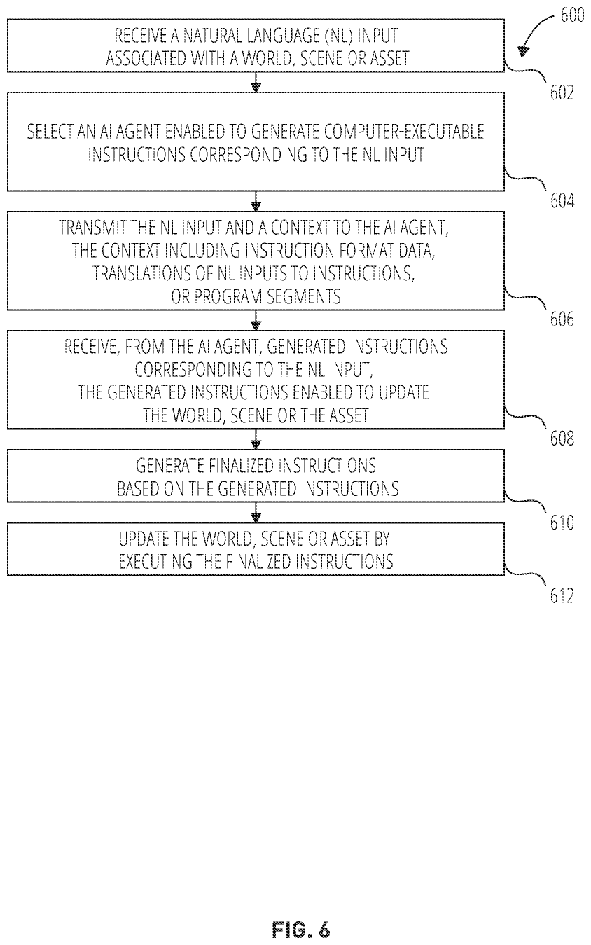

FIG. 6 is a flow diagram illustrating a method 600 implemented by an AI-assisted collaborative prototyping system 214, according to some examples.

At operation 602, the prototyping system 214 receives, at a computing device, a NL input associated with a world, scene or asset. At operation 604, the prototyping system 214 selects an AI agent enabled to generate one or more instructions corresponding to the NL input, each of the one or more instructions executable by a computer. In some examples, the prototyping system 214 uses a predetermined AI agent, bypassing the selection operation. In some examples, the output of the AI agent includes generated files comprising commands and/or data (e.g., data files) and/or paths to data or data files. At operation 606, the prototyping system 214 transmits the NL input and a context to the AI agent, the context comprising one or more of at least instruction format data, translations of NL inputs to instructions, or segments of programs. At operation 608, prototyping system 214 receives, from the AI agent, a set of generated instructions corresponding to the NL input, the set of generated instructions enabled to update the world, scene or the asset. At operation 610, the prototyping system 214 generates a set of finalized instructions based on the set of generated instructions. At operation 612, the prototyping system 214 updates, at the computing device, the world, scene or asset by executing the set of finalized instructions.

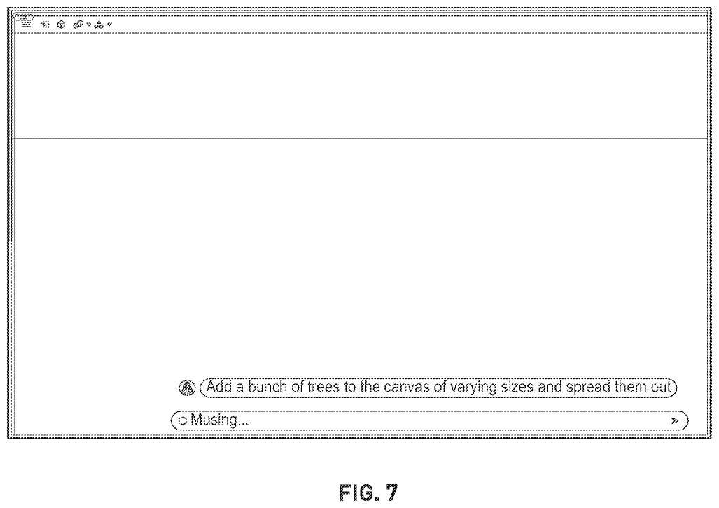

FIG. 7 is an illustration of a user interface (UI) for an AI-assisted collaborative prototyping system 214, according to some examples. The prototyping system 214 receives, via the UI, a NL prompt. In this example, the prompt corresponds to a request to draw trees. The prototyping system 214 processes the request as described in at least FIG. 2 and FIG. 3. In some examples, the prototyping system 214 processes the current NL input based on a history of user requests and their respective system-generated results, as well as additional context (e.g., including command-related information or program, subroutine or template information).

In some examples, the UI's input modality can be text, speech, selection/activation of a UI element automatically retrieved based on a user selection (e.g., a menu entry, a drag-and-drop UI asset from an asset panel etc.), or any combination of these or other modalities.

In some examples, the prototyping system 214 allows for a link to the current design session to be created and shared with one or more team members or other users. The link can be shared within the prototyping system 214 itself, or with users outside the prototyping system, via a third-party messaging app or system (e.g., Microsoft Teams, Slack, Zoom, etc.). In some examples, the prototyping system imposes a limit on the number of users who can simultaneously edit a scene or participate in a design session. In some examples, the scene can be open and editable in the UI of the prototyping system 214, in an editor (e.g., the Unity® editor application), or in other environments. Therefore, multiple users can collaborate in designing a scene or asset. For example, users can add elements in real time to the scene, move and/or manipulate them.

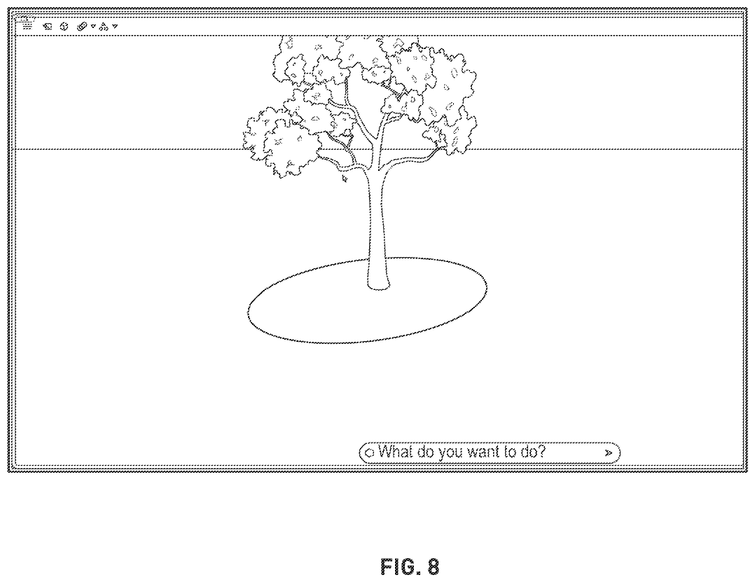

FIG. 8 is an illustration of a UI for an AI-assisted collaborative prototyping system 214, according to some examples. In this example, FIG. 8 illustrates the result of prototyping system 214 automatically mapping a request to add trees (see FIG. 7) to a set of executable commands that result in a tree being added to the scene.

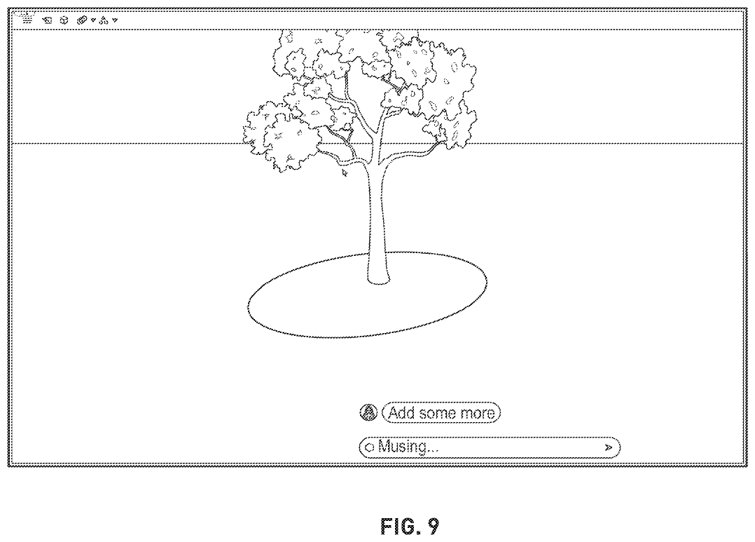

FIG. 9 is an illustration of a UI for an AI-assisted collaborative prototyping system 214, according to some examples. In this example, FIG. 9 illustrates the prototyping system 214 receiving, via the UI, a request to “add some more”. The prototyping system 214 processes this request in the context of a history of K previous requests, or prompts. The history includes the request in FIG. 7, to add multiple trees, and/or potentially the set of commands generated by the system. Therefore, the prototyping system 214 is able to disambiguate the user request and generate a set of commands for adding an additional tree to the canvas.

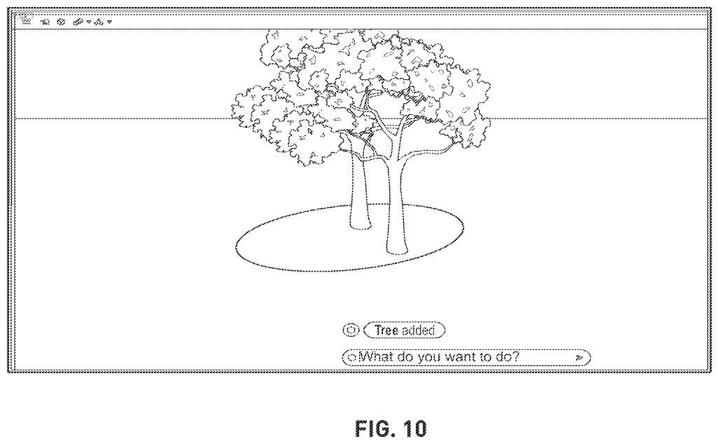

FIG. 10 is an illustration of a UI for an AI-assisted collaborative prototyping system 214, according to some examples. In this example, FIG. 10 illustrates the prototyping system 214 displaying, via the UI, a “tree added” message subsequent to rendering an additional tree, as illustrated in FIG. 9.

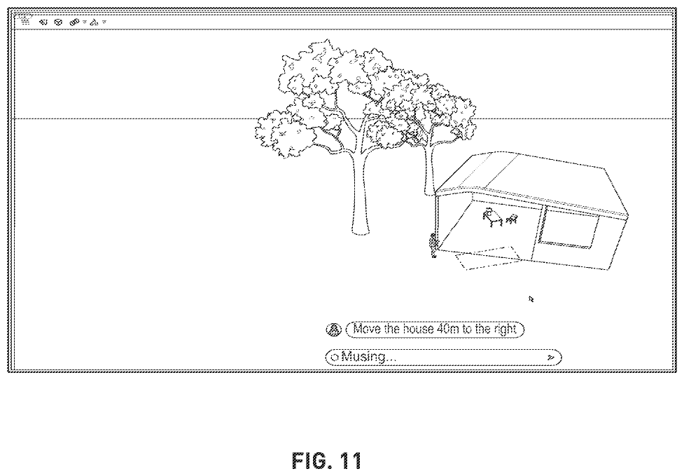

FIG. 11 is an illustration of a UI for an AI-assisted collaborative prototyping system 214, according to some examples. In this example, FIG. 11 illustrates the prototyping system 214 receiving, via the UI, a NL input requesting the house be moved to the right. In this example, the prototyping system 214 could determine for example, an “update” intent associated with the NL input, a request scope indicative of an asset-related request, and one or more topics associated with the NL input such as “house”, “world structure”, “direction”, or other topics.

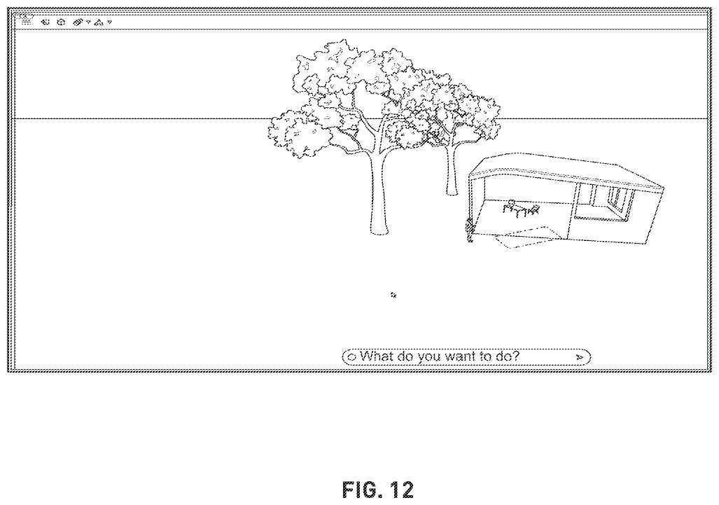

FIG. 12 is an illustration of a UI for an AI-assisted collaborative prototyping system 214, according to some examples. In this example, FIG. 12 illustrates the output of the prototyping system 214 after the system moved the house and received additional input from the user via the UI, changing the point of view of the user.

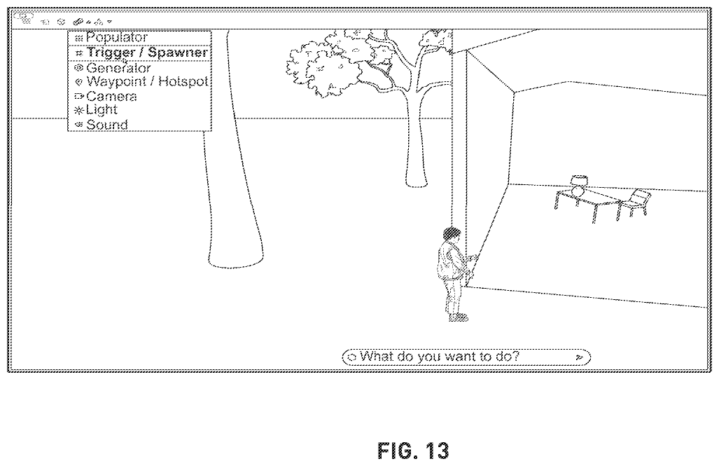

FIG. 13 is an illustration of a UI for an AI collaborative prototyping system 214, according to some examples. The UI includes a toolbar with various interactive user-selectable elements that users that perform different functions within the prototyping environment. For example, the toolbar includes options such as ‘Populator’, ‘Trigger/Spawner’, ‘Generator’, ‘Waypoint/Hotspot’, ‘Camera’, ‘Light’, and ‘Sound’. The prototyping system 214 is enabled to use user selection and/or inputs to add and configure various elements within a 3D scene, such as placing objects or characters (‘Populator’), setting up triggers or spawn points (‘Trigger/Spawner’), generating assets or scenes (‘Generator’), defining navigation points (‘Waypoint/Hotspot’), adjusting the camera view (‘Camera’), manipulating lighting effects (‘Light’), and/or incorporating audio elements (‘Sound’).

For example, upon receiving a selection of the “Trigger/Spawner” UI menu item, the prototyping system 214 can automatically add a user-selected trigger point (e.g., the entryway of the house in the example, etc) to the scene. Subsequent to the trigger point being added, the prototyping system 214 automatically detects if the trigger point is subsequently triggered during user manipulation of the scene or asset. If so, the prototyping system 214 can cause a change of position, for example by navigating directly to a different part of the scene. In this way, the prototyping system 214 enables jumping between multiple versions of an editing canvas.

In some examples, the prototyping system 214 enables the simultaneous editing of multiple scenes. For example, the prototyping system 214 receives editing input from a first user and edits a first scene, while also generating and/or editing a second scene based on input from a second user. The first user can be “inside” the depicted house and the prototyping system 214 can modify a first scene, while a second user can be “outside” the depicted house, and the prototyping system 214 can modify a second scene. If the prototyping system detects the first user moving to a hot spot corresponding to a previously added trigger point, the prototyping system 214 can automatically cause the first user to jump to the second scene (e.g., quickly go from the inside to the outside of the house).

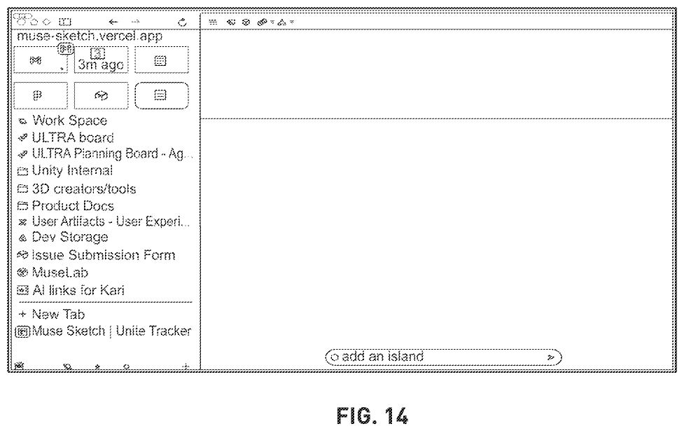

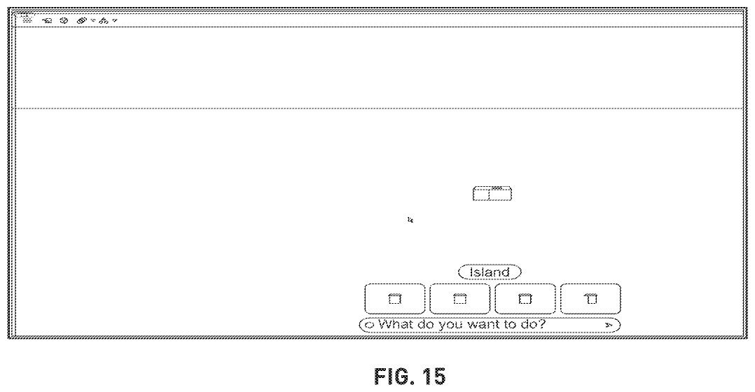

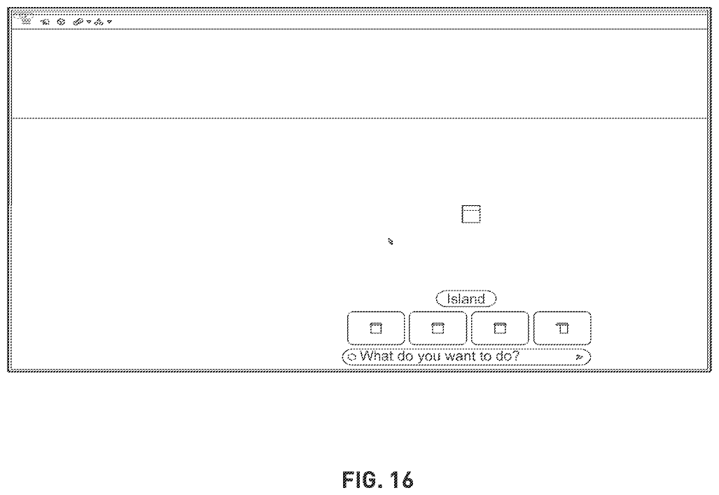

FIG. 14, FIG. 15 and FIG. 16 illustrate a UI for AI collaborative prototyping system 214, according to some examples. FIG. 14 shows the prototyping system 214 receiving a NL input requesting the system to add an island. In this case, given the brevity and ambiguity of the user-provided NL input, the prototyping system 214 does render two versions of an island, as seen in FIG. 15 and FIG. 16, but it disambiguates the request to refer to kitchen islands. In some examples, a similar result could be generated by the prototyping system 214 if the context supplies to the AI agent included a history of inputs associated with a domicile and its surroundings, such as the NL inputs illustrated in at least FIG. 8, FIG. 9, or FIG. 11.

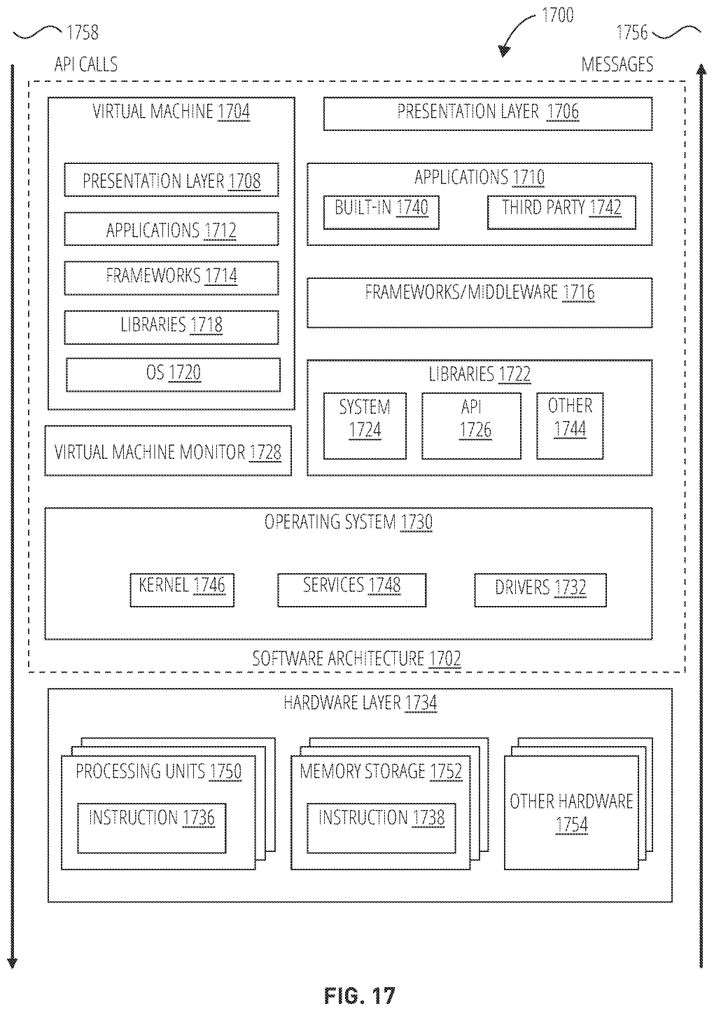

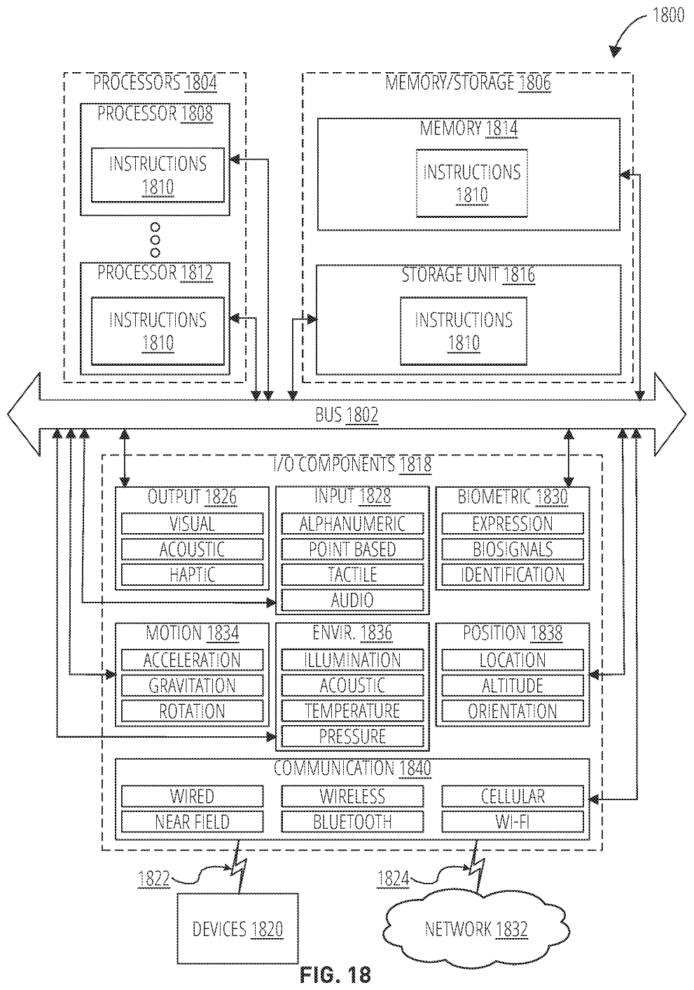

FIG. 17 is a block diagram illustrating an example of a software architecture 1702 that may be installed on a machine, according to some example embodiments. FIG. 17 is merely a non-limiting example of software architecture, and it will be appreciated that many other architectures may be implemented to facilitate the functionality described herein. The software architecture 1702 may be executing on hardware such as a machine 1800 of FIG. 18 that includes, among other things, processors 1804, memory/storage 1806, and input/output (I/O) 1818. A representative hardware layer 1734 is illustrated and can represent, for example, the machine of FIG. 18. The representative hardware layer 1734 comprises one or more processing units 1750 having associated executable instructions 1736. The executable instructions 1736 represent the executable instructions of the software architecture 1702. The hardware layer 1734 also includes memory or memory storage 1752, which also have the executable instructions 1738. The hardware layer 1734 may also comprise other hardware 1754, which represents any other hardware of the hardware layer 1734 such as the other hardware illustrated as part of the machine 1800.

In the example architecture of FIG. 17, the software architecture 1702 may be conceptualized as a stack of layers, where each layer provides particular functionality. For example, the software architecture 1702 may include layers such as an operating system 1730, libraries 1718, frameworks/middleware 1716, applications 1710, and a presentation layer 1708. Operationally, the applications 1710 or other components within the layers may invoke API calls 1758 through the software stack and receive a response, returned values, and so forth (illustrated as messages 1756) in response to the API calls 1758. The layers illustrated are representative in nature, and not all software architectures have all layers. For example, some mobile or special-purpose operating systems may not provide a frameworks/middleware 1716 layer, while others may provide such a layer. Other software architectures may include additional or different layers.

The operating system 1730 may manage hardware resources and provide common services. The operating system 1730 may include, for example, a kernel 1746, services 1748, and drivers 1732. The kernel 1746 may act as an abstraction layer between the hardware and the other software layers. For example, the kernel 1746 may be responsible for memory management, processor management (e.g., scheduling), component management, networking, security settings, and so on. The services 1748 may provide other common services for the other software layers. The drivers 1732 may be responsible for controlling or interfacing with the underlying hardware. For instance, the drivers 1732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1718 may provide a common infrastructure that may be utilized by the applications 1710 and/or other components and/or layers. The libraries 1718 typically provide functionality that allows other software modules to perform tasks in an easier fashion than by interfacing directly with the underlying operating system 1730 functionality (e.g., kernel 1746, services 1748 or drivers 1732). The libraries 1718 may include system libraries 1718 (e.g., C standard library) that may provide functions such as memory allocation functions, string manipulation functions, mathematic functions, and the like. In addition, the libraries 1718 may include API libraries 1028 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1718 may also include a wide variety of other libraries 1722 to provide many other APIs to the applications 1710 or applications 1712 and other software components/modules.

The frameworks 1714 (also sometimes referred to as middleware) may provide a higher-level common infrastructure that may be utilized by the applications 1710 or other software components/modules. For example, the frameworks 1714 may provide various graphical user interface functions, high-level resource management, high-level location services, and so forth. The frameworks 1714 may provide a broad spectrum of other APIs that may be utilized by the applications 1710 and/or other software components/modules, some of which may be specific to a particular operating system or platform.

The applications 1710 include built-in applications 1740 and/or third-party applications 1742. Examples of representative built-in applications 1740 may include, but are not limited to, a home application, a contacts application, a browser application, a book reader application, a location application, a media application, a messaging application, or a game application.

The third-party applications 1742 may include any of the built-in applications 1740 as well as a broad assortment of other applications. In a specific example, the third-party applications 1742 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1742 may invoke the API calls 1758 provided by the mobile operating system such as the operating system 1730 to facilitate functionality described herein.

The applications 1710 may utilize built-in operating system functions, libraries (e.g., system libraries 1724, API libraries 1726, and other libraries), or frameworks/middleware 1716 to create user interfaces to interact with users of the system. Alternatively, or additionally, in some systems, interactions with a user may occur through a presentation layer, such as the presentation layer 1708. In these systems, the application/module “logic” can be separated from the aspects of the application/module that interact with the user.

Some software architectures utilize virtual machines. In the example of FIG. 17, this is illustrated by a virtual machine 1704. The virtual machine 1704 creates a software environment where applications/modules can execute as if they were executing on a hardware machine. The virtual machine 1704 is hosted by a host operating system (e.g., the operating system 1730) and typically, although not always, has a virtual machine monitor 1728, which manages the operation of the virtual machine 904 as well as the interface with the host operating system (e.g., the operating system 1730). A software architecture executes within the virtual machine 1704, such as an operating system 1730, libraries 1718, frameworks/middleware 1716, applications 1712, or a presentation layer 1708. These layers of software architecture executing within the virtual machine 1704 can be the same as corresponding layers previously described or may be different.

FIG. 18 is a block diagram illustrating components of a machine 1800, according to some example embodiments, able to read instructions from a machine-readable medium (e.g., a machine-readable storage medium) and perform any one or more of the methodologies discussed herein. Specifically, FIG. 18 shows a diagrammatic representation of the machine 1800 in the example form of a computer system, within which instructions 1810 (e.g., software, a program, an application, an applet, an app, or other executable code) for causing the machine 1800 to perform any one or more of the methodologies discussed herein may be executed. As such, the instructions 1810 may be used to implement modules or components described herein. The instructions 1810 transform the general, non-programmed machine 1800 into a particular machine 1800 to carry out the described and illustrated functions in the manner described. In alternative embodiments, the machine 1800 operates as a standalone device or may be coupled (e.g., networked) to other machines. In a networked deployment, the machine 1800 may operate in the capacity of a server machine or a client machine in a server-client network environment, or as a peer machine in a peer-to-peer (or distributed) network environment. The machine 1800 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 1810, sequentially or otherwise, that specify actions to be taken by machine 1800. Further, while only a single machine 1800 is illustrated, the term “machine” shall also be taken to include a collection of machines that individually or jointly execute the instructions 1810 to perform any one or more of the methodologies discussed herein.

The machine 1800 may include processors 1804, memory/storage 1806, and I/O components 1818, which may be configured to communicate with each other such as via a bus 1802. The memory/storage 1806 may include a memory 1814, such as a main memory, or other memory storage, and a storage unit 1816, both accessible to the processors 1804 such as via the bus 1802. The storage unit 1816 and memory 1814 store the instructions 1810 embodying any one or more of the methodologies or functions described herein. The instructions 1810 may also reside, completely or partially, within the memory 1814 within the storage unit 1816, within at least one of the processors 1804 (e.g., within the processor's cache memory), or any suitable combination thereof, during execution thereof by the machine 1800. Accordingly, the memory 1814 the storage unit 1816, and the memory of processors 1804 are examples of machine-readable media.

The I/O components 1818 may include a wide variety of components to receive input, provide output, produce output, transmit information, exchange information, capture measurements, and so on. The specific I/O components 1818 that are included in a particular machine 1800 will depend on the type of machine. For example, portable machines such as mobile phones will likely include a touch input device or other such input mechanisms, while a headless server machine will likely not include such a touch input device. It will be appreciated that the I/O components 1818 may include many other components that are not shown in FIG. 11. The I/O components 1818 are grouped according to functionality merely for simplifying the following discussion and the grouping is in no way limiting. In various example embodiments, the I/O components 1818 may include output components 1826 and input components 1828. The output components 1826 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1828 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1818 may include biometric components 1830, motion components 1834, environmental environment components 1836, or position components 1838 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1834 may include acceleration sensor components (e.g., accelerometer), gravitation sensor components, rotation sensor components (e.g., gyroscope), and so forth. The environment components 1836 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1838 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1818 may include communication components 1840 operable to couple the machine 1800 to a network 1832 or devices 1820 via coupling 1822 and coupling 1824 respectively. For example, the communication components 1840 may include a network interface component or other suitable device to interface with the network 1832. In further examples, communication components 1840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1820 may be another machine or any of a wide variety of peripheral devices (e.g., a peripheral device coupled via a Universal Serial Bus (USB)).

Moreover, the communication components 1840 may detect identifiers or include components operable to detect identifiers. For example, the communication components 1840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1840, such as, location via Internet Protocol (IP) geo-location, location via Wi-Fi® signal triangulation, location via detecting a NFC beacon signal that may indicate a particular location, and so forth.

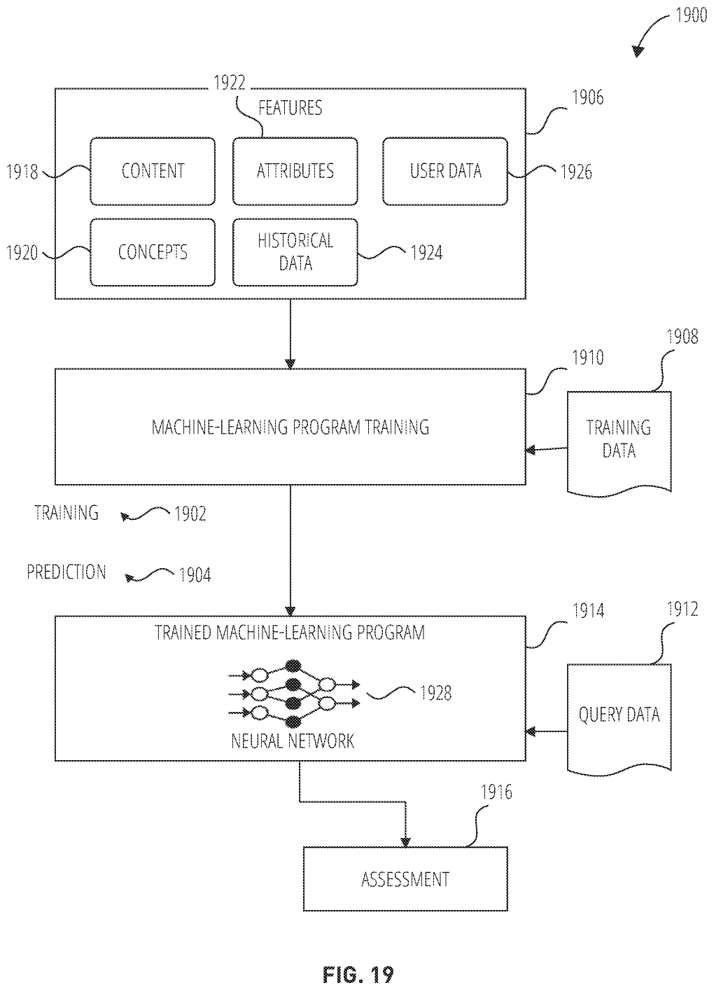

FIG. 19 is a block diagram showing a machine-learning program 1900 according to some examples. The machine-learning programs 1900, also referred to as machine-learning algorithms or tools, are used to train machine learning models, which can be used by one or more AI agents in the prototyping system 214.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 1908 in order to make data-driven predictions or decisions expressed as outputs or assessments (e.g., assessment 1916). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g., stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 1900 supports two types of phases, namely a training phase 1902 and prediction phase 1904. In a training phase 1902, supervised learning, unsupervised or reinforcement learning may be used. For example, the machine-learning program 1900 (1) receives features 1906 (e.g., as structured or labeled data in supervised learning) and/or (2) identifies features 1906 (e.g., unstructured or unlabeled data for unsupervised learning) in training data 1908. In a prediction phase 1904, the machine-learning program 1900 uses the features 1906 for analyzing query data 1912 to generate outcomes or predictions, as examples of an assessment 1916.

In the training phase 1902, feature engineering is used to identify features 1906 and may include identifying informative, discriminating, and independent features for the effective operation of the machine-learning program 1900 in pattern recognition, classification, and regression. In some examples, the training data 1908 includes labeled data, which is known data for pre-identified features 1906 and one or more outcomes. Each of the features 1906 may be a variable or attribute, such as individual measurable property of a process, article, system, or phenomenon represented by a data set (e.g., the training data 1908). Features 1906 may also be of different types, such as numeric features, strings, and graphs, and may include one or more of content 1918, concepts 1920, attributes 1922, historical data 1924 and/or user data 1926, merely for example.

In training phases 1902, the machine-learning program 1900 uses the training data 1908 to find correlations among the features 1906 that affect a predicted outcome or assessment 1916.

With the training data 1908 and the identified features 1906, the machine-learning program 1900 is trained during the training phase 1902 at machine-learning program training 1910. The machine-learning program 1900 appraises values of the features 1906 as they correlate to the training data 1908. The result of the training is the trained machine-learning program 1914 (e.g., a trained or learned model).

Further, the training phases 1902 may involve machine learning, in which the training data 1908 is structured (e.g., labeled during preprocessing operations), and the trained machine-learning program 1914 implements a relatively simple neural network 1928 (or one of other machine learning models, as described herein) capable of performing, for example, classification and clustering operations. In other examples, the training phase 1902 may involve deep learning, in which the training data 1908 is unstructured, and the trained machine-learning program 1914 implements a deep neural network 1928 that is able to perform both feature extraction and classification/clustering operations.

A neural network 1928 generated during the training phase 1902, and implemented within the trained machine-learning program 1914, may include a hierarchical (e.g., layered) organization of neurons. For example, neurons (or nodes) may be arranged hierarchically into a number of layers, including an input layer, an output layer, and multiple hidden layers. The layers within the neural network 1928 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 1928 may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), or a Recursive Neural Network (RNN), merely for example.

During prediction phases 1904 the trained machine-learning program 1914 is used to perform an assessment. Query data 1912 is provided as an input to the trained machine-learning program 1914, and the trained machine-learning program 1914 generates the assessment 1916 as output, responsive to receipt of the query data 1912.

A trained neural network model (e.g., a trained machine learning program 1914 using a neural network 1928) may be stored in a computational graph format, according to some examples. An example computational graph format is the Open Neural Network Exchange (ONNX) file format, an open, flexible standard for storing models which allows reusing models across deep learning platforms/tools, and deploying models in the cloud (e.g., via ONNX runtime).

In some examples, the ONNX file format corresponds to a computational graph in the form of a directed graph whose nodes (or layers) correspond to operators and whose edges correspond to tensors. In some examples, the operators (or operations) take the incoming tensors as inputs, and output result tensors, which are in turn used as inputs by their children.

In some examples, trained neural network models (e.g., examples of trained machine learning programs 1914) developed and trained using frameworks such as TensorFlow, Keras, PyTorch, and so on can be automatically exported to the ONNX format using framework-specific export functions. For instance, PyTorch allows the use of a torch.export(trainedModel, outputFile ( . . . )) function to export a trained model ready to be run to a file using the ONNX file format. Similarly, TensorFlow and Keras allow the use of the tf2onnx library for converting trained models to the ONNX file format, while Keras also allows the use of keras2onnx for the same purpose.

In example embodiments, one or more artificial intelligence agents, such as one or more machine-learned algorithms or models and/or a neural network of one or more machine-learned algorithms or models may be trained iteratively (e.g., in a plurality of stages) using a plurality of sets of input data. For example, a first set of input data may be used to train one or more of the artificial agents. Then, the first set of input data may be transformed into a second set of input data for retraining the one or more artificial intelligence agents. The continuously updated and retrained artificial intelligence agents may then be applied to subsequent novel input data to generate one or more of the outputs described herein.

### Examples

Example 1 is a computer-implemented method comprising: receiving, at a computing device, a natural language (NL) input associated with a world, a scene or an asset; transmitting the NL input and a context to an AI agent configured to generate one or more instructions corresponding to the NL input, each of the one or more instructions executable by a computer, the context comprising one or more of at least instruction format data, translations of NL inputs to instructions, or segments of programs; receiving, from the AI agent, a set of generated instructions corresponding to the NL input, the set of generated instructions configured to update at least one of the world, the scene or the asset; generating a set of finalized instructions based on the set of generated instructions; and updating the world, the scene or the asset by executing the set of finalized instructions.

In Example 2, the subject matter of Example 1 includes, selecting the AI agent based on determining one of at least an intent associated with the NL input, a request scope associated with the NL input, or a topic associated with the NL input.

In Example 3, the subject matter of Examples 1-2 includes, wherein the context transmitted to the AI agent further comprises one of at least a plurality of previous NL inputs, or a plurality of pairs, each pair comprising a previous NL input and a set of instructions.

In Example 4, the subject matter of Examples 1-3 includes, determining NL input information comprising one of at least an intent of the NL input, a request scope of the NL input, or a topic of the NL input; generating the context based on the determined NL input information.

In Example 5, the subject matter of Example 4 includes, wherein: the intent associated with the NL input is determined to be one of a select intent, create intent, add intent, update intent, move intent or delete intent; the request scope of the NL input is determined to be associated with the asset or the scene; and generating the context based on the determined NL input information further comprises adding to the context the instruction format data, or the translations of NL inputs to instructions.

In Example 6, the subject matter of Examples 4-5 includes, wherein: the intent associated with the NL input is determined to be a create intent; the request scope of the NL input is determined to be associated with the world; and generating the context based on the determined NL input information further comprises adding to the context the segments of programs.

In Example 7, the subject matter of Examples 1-6 includes, wherein generating the set of finalized instructions further comprises: transmitting an input and a second context to the AI agent, the input comprising one or more of the instructions in the set of generated instructions, the context comprising verification information associated with the one or more instructions; receiving, from the AI agent, a second set of generated instructions; generating the set of finalized instructions based on the set of generated instructions and the second set of generated instructions.

In Example 8, the subject matter of Examples 1-7 includes, selecting a second artificial intelligence (AI) agent configured to generate a second set of instructions corresponding to the NL input; and wherein generating the finalized set of instructions is further based on the second set of instructions.

In Example 9, the subject matter of Examples 1-8 includes, receiving the NL input via a user interface (UI); and displaying the updated world, scene or asset via a second UI.

In Example 10, the subject matter of Examples 1-9 includes, wherein the NL input is received from a first user and the method further comprises: receiving a second NL input from a second user, the second NL input being associated with the world, a second scene or a second asset;

Example 11 is at least one non-transitory, machine-readable medium (or computer-readable) including instructions that, when executed by processing circuitry, cause the processing circuitry to perform operations to implement of any of Examples 1-10.

Example 12 is an apparatus comprising means to implement of any of Examples 1-10.

Example 13 is a system to implement of any of Examples 1-10.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

“SHADER” in this context refers to a program that runs on a GPU, a CPU, a TPU and so forth. In the following, a non-exclusive listing of types of shaders is offered. Shader programs may be part of a graphics pipeline. Shaders may also be compute shaders or programs that perform calculations on a CPU or a GPU (e.g., outside of a graphics pipeline, etc.). Shaders may perform calculations that determine pixel properties (e.g., pixel colors). Shaders may refer to ray tracing shaders that perform calculations related to ray tracing. A shader object may (e.g., an instance of a shader class) may be a wrapper for shader programs and other information. A shader asset may refer to a shader file (or a “.shader” extension file), which may define a shader object.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

1. A computer-implemented method comprising:
receiving, at a computing device, a natural language (NL) input associated with a world, a scene or an asset;
transmitting the NL input and a context to an AI agent configured to generate one or more instructions corresponding to the NL input, each of the one or more instructions executable by one or more computer processors, the context comprising one or more of at least instruction format data, translations of NL inputs to instructions, or segments of programs;
receiving, from the AI agent, a set of generated instructions corresponding to the NL input, the set of generated instructions configured to update at least one of the world, the scene or the asset;
generating a set of finalized instructions based on the set of generated instructions; and
updating the world, the scene or the asset by executing the set of finalized instructions.

2. The computer-implemented method of claim 1, further comprising selecting the AI agent based on determining one of at least an intent associated with the NL input, a request scope associated with the NL input, or a topic associated with the NL input.

3. The computer-implemented method of claim 1, wherein the context transmitted to the AI agent further comprises one of at least a plurality of previous NL inputs, or a plurality of pairs, each pair comprising a previous NL input and a set of instructions.

4. The computer-implemented method of claim 1, further comprising:
determining NL input information comprising one of at least an intent of the NL input, a request scope of the NL input, or a topic of the NL input;
generating the context based on the determined NL input information.

5. The computer-implemented method of claim 4, wherein:
the intent associated with the NL input is determined to be one of a select intent, create intent, add intent, update intent, move intent or delete intent;
the request scope of the NL input is determined to be associated with the asset or the scene; and
generating the context based on the determined NL input information further comprises adding to the context the instruction format data, or the translations of NL inputs to instructions.

6. The computer-implemented method of claim 4, wherein:
the intent associated with the NL input is determined to be a create intent;
the request scope of the NL input is determined to be associated with the world; and
generating the context based on the determined NL input information further comprises adding to the context the segments of programs.

7. The computer-implemented method of claim 1, wherein generating the set of finalized instructions further comprises:
transmitting an input and a second context to the AI agent, the input comprising one or more of the instructions in the set of generated instructions, the context comprising verification information associated with the one or more instructions;
receiving, from the AI agent, a second set of generated instructions;
generating the set of finalized instructions based on the set of generated instructions and the second set of generated instructions.

8. The computer-implemented method of claim 1, further comprising:
selecting a second artificial intelligence (AI) agent configured to generate a second set of instructions corresponding to the NL input; and wherein
generating the finalized set of instructions is further based on the second set of instructions.

9. The computer-implemented method of claim 1, further comprising:
receiving the NL input via a user interface (UI); and
displaying the updated world, scene or asset via a second UI.

10. The computer-implemented method of claim 1, wherein the NL input is received from a first user and the method further comprises:
receiving a second NL input from a second user, the second NL input being associated with the world, a second scene or a second asset;
transmitting the second NL input and a second context to the AI agent, the second context comprising one or more of at least a second set of instruction format data, a second set of translations of NL inputs to instructions, or a second set of segments of programs;
receiving, from the AI agent, a second set of generated instructions corresponding to the second NL input, the second set of generated instructions configured to update the world, the second scene or the second asset;
generating a second set of finalized instructions based on the second set of generated instructions; and
updating, at the computing device, the world, the second scene or the second asset by executing the set of finalized instructions.

11. A system comprising:
one or more computer processors;
one or more computer memories; and
a set of instructions stored in the one or more computer memories, the set of instructions configuring the one or more computer processors to perform operations, the operations comprising:
receiving, at a computing device, a natural language (NL) input associated with a world, scene or asset;
transmitting the NL input and a context to an AI agent configured to generate one or more instructions corresponding to the NL input, each of the one or more instructions executable by a computer, the context comprising one or more of at least instruction format data, translations of NL inputs to instructions, or segments of programs;
receiving, from the AI agent, a set of generated instructions corresponding to the NL input, the set of generated instructions configured to update at least one of the world, the scene or the asset;
generating a set of finalized instructions based on the set of generated instructions; and
updating the world, the scene or the asset by executing the set of finalized instructions.

12. The system of claim 11, further comprising selecting the AI agent based on determining at least one of an intent associated with the NL input, a request scope associated with the NL input, or a topic of the NL input.

13. The system of claim 11, wherein the context transmitted to the AI agent further comprises one of at least a plurality of previous NL inputs, or a plurality of pairs, each pair comprising a previous NL input and a set of instructions.

14. The system of claim 11, the operations further comprising:
determine NL input information comprising one of at least an intent of the NL input, a request scope of the NL input, or a topic of the NL input;
generate the context based on the determined NL input information.

15. The system of claim 14, wherein:
the intent associated with the NL input is determined to be one of a select intent, create intent, add intent, update intent, move intent or delete intent;
the request scope of the NL input is determined to be associated with the asset or the scene; and
generate the context based on the determined NL input information further comprises adding to the context the instruction format data or the translations of NL inputs to instructions.

16. The system of claim 14, wherein:
the intent associated with the NL input is determined to be a create intent;
the request scope of the NL input is determined to be associated with the world; and
generate the context based on the determined NL input information further comprises adding to the context the segments of programs.

17. The system of claim 11, wherein generating the set of finalized instructions further comprises:
transmitting an input and a second context to the AI agent, the input comprising one or more of the instructions in the set of generated instructions, the context comprising verification information associated with the one or more instructions;
receiving, from the AI agent, a second set of generated instructions;
generating the set of finalized instructions by combining the set of generated instructions and the second set of generated instructions.

18. The system of claim 11, the operations further comprising:
receive the NL input via a user interface (UI); and
display the updated world, scene or asset via a second UI.

19. The system of claim 11, wherein the NL input is received from a first user and the operations further comprise:
receiving a second NL input from a second user, the second NL input being associated with the world, a second scene or a second asset;
transmitting the second NL input and a second context to the AI agent, the second context comprising one or more of at least a second set of instruction format data, a second set of translations of NL inputs to instructions, or a second set of segments of programs;
receiving, from the AI agent, a second set of generated instructions corresponding to the second NL input, the second set of generated instructions configured to update the world, the second scene or the second asset;
generating a second set of finalized instructions based on the second set of generated instructions; and
updating, at the computing device, the world, the second scene or the second asset by executing the set of finalized instructions.

20. A non-transitory computer-readable storage medium storing instructions that, when executed by at least one processor, cause the at least one processor to perform operations comprising:
receive, at a computing device, a natural language (NL) input associated with a world, scene or asset;
transmitting the NL input and a context to an AI agent configured to generate one or more instructions corresponding to the NL input, each of the one or more instructions executable by a computer, the context comprising one or more of at least instruction format data, translations of NL inputs to instructions, or segments of programs;
receiving, from the AI agent, a set of generated instructions corresponding to the NL input, the set of generated instructions configured to update at least one of the world, the scene or the asset;
generating a set of finalized instructions based on the set of generated instructions; and
updating the world, the scene or the asset by executing the set of finalized instructions.
